(19) United States
(12) Patent Application Publication
(10) Pub. No.: US 2006/0150605 A1
(43) Pub. Date: Jul. 13, 2006

(54) Vehicle for supporting a crop picking head with an adjustable suspension

(76) Inventors: Richard Wubbels, Rhede (DE); Thomas Lukas, Ahaus-Wullen (DE)

Correspondence Address: DEERE & COMPANY, ONE JOHN DEERE PLACE, MOLINE, IL, 61265, US

(21) Appl. No.: 11/305,387

(22) Filed: Dec. 16, 2005

(30) Foreign Application Priority Data
Jan. 12, 2005 (DE) 10 2005 001 412.7

(51) Int. Cl. A01D 34/64

(52) U.S. Cl. 56/15.8

(57) ABSTRACT

A vehicle for supporting a crop picking head attached to a self-propelled harvester during over-the-road transportation in order to reduce the load on the wheels of the harvester in order to meet regulatory requirements. The vehicle is attached to the crop picking head in preparation for road travel and detached before harvesting a field. The vehicle features a mount and at least one wheel supported downward from the mount. Furthermore, the wheel is suspended from the mount through a spring element capable of absorbing irregularities in the road surface. Preferably the spring element is a hydraulic cylinder connected to a pressure reservoir, wherein the pressure reservoir operates independently of the harvester's hydraulic system, provides damping for the hydraulic cylinder, and may be set at various pressures based on the load and road conditions.

### BACKGROUND OF THE INVENTION

1. Field of the Invention

The present invention generally relates to agricultural machinery for the harvesting of fields. More specifically, the invention relates to a removable support vehicle for a crop picking head used on a self-propelled harvester.

2. Description of Related Art

On self-propelled harvesters, crop picking heads are used for the harvesting and gathering of a crop. Recently, harvesters have become larger and the associated crop picking heads are correspondingly wider and more massive. While some attachments, such as sickle sets for combines, are rigid and must be detached from the combine and put on a transport vehicle for over-the-road transportation, corn pickers and corn huskers for pick-up choppers are usually produced in a flip-up design. In such a configuration, the exterior side parts of the crop picking heads are raised into a transport position, usually upward or towards the inside. This allows the attachments to remain coupled to the front end of the harvester during transport. However, the weight of the attachment often means the loading on the front wheels of the harvester may exceed the legal limit for the road on which it is traveling.

In U.S. Pat. No. 6,282,875 it was proposed to provide an additional wheel that could be dropped to the ground for the support of the crop picking head during over-the-road transportation of the harvester. This provides supplemental support to enable compliance with weight regulations. In one design the additional wheel is mounted on a separate vehicle which can be slid under and attached to the crop picking head. Furthermore, the wheel may be suspended from the vehicle using a spring suspension and a hydraulic cylinder may be used to move the wheel between an operating and non-operating position.

The purpose of the spring suspension is to improve the road travel performance of the harvesting machine with the crop picking head and vehicle attached since the spring allows the wheel to absorb bumps. However, the lack of damping of the spring may cause unwanted oscillations of the overall combination of the vehicle and crop picking head when driving on the rough stretches of road common in agricultural areas. The hydraulic cylinder disclosed in the art only serves to raise or lower the wheel and cannot influence the dynamic performance of the overall combination.

In U.S. Pat. No. 6,789,379, another support wheel arrangement for an agricultural machine is described. A lifting cylinder with an adjustable load support connects the additional wheel to the intake housing of the harvesting machine or to the actual harvesting machine. The lifting cylinder is connected to a pressure reservoir and, in order to set the desired load bearing of the wheel, the reservoir is impinged on with pressure from the harvesting machine. During road transport the pressure reservoir is fed pressure from the harvesting machine which varies based on the amount of grain in the grain tank.

In the above reference, the pressure reservoir is also connected to a hydraulic cylinder through a check valve. The hydraulic cylinder is used to lift the intake housing vertically around a horizontal axis perpendicular to the forward direction. If pressure peaks appear in the hydraulic cylinder when vertically swinging the intake housing, they are absorbed by the pressure reservoir. One disadvantage of this hydraulic system is high cost. Another, more significant disadvantage, is the lifting cylinder of the additional wheel also receives, through the pressure reservoir, the pressure peaks caused by the hydraulic cylinder. This can force the additional wheel down, thereby raising the crop picking head, and inducing additional, larger pressure peaks in the hydraulic cylinder which is again transferred to the lifting cylinder through the pressure reservoir. As a result, the system may degrade into an unstable condition.

In view of the above, it is apparent that there exists a need for an adjustable suspension capable of dampening disturbances, caused by irregular road surfaces, to a vehicle supporting a crop picking head in a stable manner. An objective of this invention is therefore to provide a vehicle for the support of a crop picking head with a variable load hydraulic suspension system capable of damping disturbances caused by the road surface independently of the harvester is hydraulic system.

### BRIEF SUMMARY OF THE INVENTION

In satisfying the above need, as well as overcoming the enumerated drawbacks and other limitations of the related art, the present invention discloses a vehicle for the support of a crop picking head during over-the-road transport which includes an inexpensive, variable load hydraulic suspension system that dampens disturbances independently of the harvester hydraulic system.

More specifically, disclosed herein is the combination of a harvesting machine, a crop picking head, and a vehicle to support the crop picking head wherein the vehicle features a mount and at least one wheel extending downward from the mount and being suspended on the mount through a spring element. The vehicle supports the crop picking head, alleviates the weight of the crop picking head on the front wheels of the self-propelled harvesting machine during road travel and is detachable from the crop picking head for harvesting operations in a field.

The spring element includes of a hydraulic cylinder connected to the wheel and the mount. An appropriate chamber of the hydraulic cylinder is connected to a pressure reservoir and, during road transport, forms a closed hydraulic system unconnected with the hydraulic system of the harvesting machine. As a result, suspension of the wheel during transport is achieved through a simple, uncomplicated, and reliable means, without unwanted oscillations.

In a preferred embodiment, the vehicle includes a trailing arm coupled to the wheel and a holder. The holder is coupled to the trailing arm at joint pivoting about a horizontal axis running parallel to the axis of revolution of the wheel. The hydraulic cylinder extends between the trailing arm and the holder. The holder is further coupled to the mount, preferably at a joint swiveling about a nearly vertical axis, and the mount is attached to the crop picking head.

The pressure in the hydraulic cylinder is set to achieve the desired road performance. The setting varies based, among other things, on the mass of the crop picking head and the actual road conditions. The pressure reservoir, the hydraulic cylinder, or a tube connecting the two, may be temporarily attached to the hydraulic system of the harvesting machine to set the initial pressure or to make subsequent pressure adjustments. A pressure reducer or a pressure controller is used to set the desired pressure in the hydraulic cylinder and a pressure gauge is provided to monitor the pressure in the reservoir. After setting or adjusting the pressure, the hydraulic system of the vehicle is disconnected from the hydraulic system of the harvester.

These and other aspects and advantages of the present invention will become apparent upon reading the following detailed description of the invention in combination with the accompanying drawings.

### BRIEF DESCRIPTION OF THE DRAWINGS

The drawings show a design example of the invention which is described in more detail below:

FIG. 1 is a side view of the front of the intake housing of a harvester with a crop picking head and a support vehicle, attached to the crop picking head, embodying the principles of the present invention.

### DETAILED DESCRIPTION OF THE INVENTION

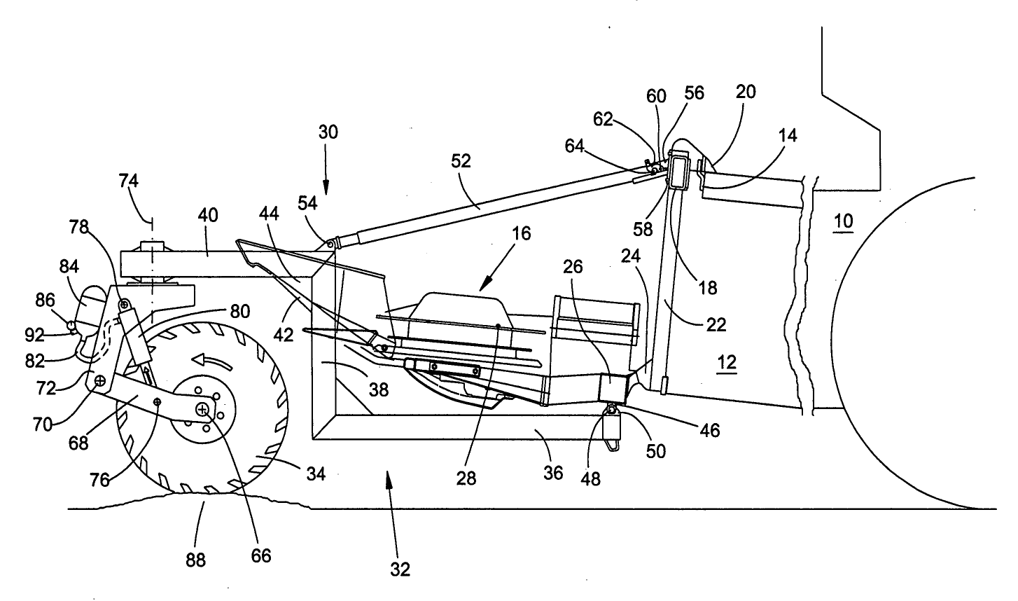

The front of an agricultural harvesting machine 10 is shown in FIG. 1 in the style of a self-propelled harvester to which is attached a crop picking head 16. Crops, such as corn, sunflower or sorghum, picked by means of the crop picking head 16 are fed via a intake housing 12 to a chopping drum (not shown) inside the harvesting machine 10, which chops the crop into small pieces and loads it onto conveying machinery (not shown) within the machine 10. The crop is then emptied from the harvesting machine 10 into a trailer driving alongside or behind the machine 10. A secondary crusher, not shown in the drawing, may be positioned between the chopping drum and the conveying machinery. Although the invention is being shown on a field chopper, it is to be understood that it may also be used on combine harvesting machines with appropriate crop picking heads, such as cutter bars or maize pickers, or other machines.

In the following, directions such as in front, behind, laterally and above, refer to the forward direction of the harvesting machine 10 and the crop picking head 16, which is to the left in FIG. 1.

As indicated above, the crop picking head 16, fastened in the forward direction on the front end of the harvesting machine 10, picks the crops to be harvested. In the embodiment shown, the crop picking head 16 is a known corn picker head including harvesting equipment 28. The harvesting equipment 28 of the crop picking head 16 is mounted to a frame, which has a hollow lower cross bar 26 and an upper cross bar 18. The lower cross bar 26 extends underneath the rear of the crop picking head 16. A drive shaft (not shown), driven by a power take off of the harvesting machine 10, extends laterally within the lower cross bar 26 and powers the harvesting equipment 28 of the crop picking head 16.

The upper cross bar 18 extends laterally across the width and above the entrance of the intake housing 12. Hook-shaped supporting members 14 and 20 are provided on the top side of the intake housing 12, which support the upper cross bar 18 and fasten the crop picking head 16 to the intake housing 12 of the harvesting machine 10. The upper cross bar 18 is connected to the lower cross bar 26 through vertical supports 22 and connecting plates 24. Thus, the cross bars 18, 26, the vertical supports 22 and the connecting plates 24 form the frame that supports all the elements of the crop picking head 16.

In FIG. 1, a vehicle 30 for supporting the crop picking head 16 during road travel is also shown. It is made up of a mount 32 and a wheel 34. The mount 32 includes a rear part 36, which spreads out in a triangular fashion toward the back and is connected to a front part 40 via approximately vertically running braces 38. On the side of the front part 40, facing the rear part 36, is a vehicle positioning mechanism 44, which has a pocket or bag-like opening, shown directed to the right in FIG. 1, whose underside extends diagonally toward the back and downward toward the rear part 36. A separator tip 42 of the crop picking head 16 is inserted into the vehicle positioning mechanism 44 to automatically orient the vehicle 30 with respect to the crop picking head 16.

The vehicle 30 is fastened to the crop picking head 16 at four locations. Two brackets 46 are welded to the underside of the lower cross bar 26 and correspondingly connected to supports 50 fastened outside on the rear, upper surface of the rear part 36 by means of removable retention pins 48. The retention pins 48 each extend through coaxial openings in the bracket 46 and in the support 50. In addition, the upper cross bar 18 is enclosed by two brackets 58 bolted thereto, positioned laterally side by side. Each bracket 58 further supports a receiving device 56. Bearing on each receiving device 56 is the rear end of one of two braces 52 arranged laterally side by side and coupled at their front end around a horizontal shaft 54 running transverse to the forward direction on top of the rear portion of the front part 40 of the vehicle 30. Two latches 62, coupled to the receiving device 56 around a shaft 60, running horizontally and transverse to the forward direction, enclose from above a pin 64, which also runs horizontally and transverse to the forward direction, fastened to the rear of each brace 52.

When the vehicle 30 must be separated from the crop picking head 16 for the harvesting operation, the crop picking head 20 is raised by operating suitable hydraulic cylinders of the harvesting machine 10 to unburden the wheel 34. The latches 62 are loosened, in some configurations by an operator in a cabin of the harvesting machine 10, by means of a known Bowden cable (not shown) or other means, which extends from at least one latch 62 into the cabin. Afterwards, a lever (not shown) on the vehicle 30 is swung forward to lift the braces 52 and, by means of another Bowden cable or other means, to release the retention pins 48. The harvesting machine 10 then backs away from the vehicle 30. Attaching the vehicle 30 is done in the reverse sequence. To avoid having the operator leave the cabin to attach or remove the vehicle 30 from the crop picking head 16, locking devices, actuated by an external force, e.g. hydraulic cylinders, that can be controlled from the cabin, may also be provided to release the retention pins 48, the latches 62 and to move the braces 52.

Looking more particularly at the wheel 34, it rotates around an axis of revolution 66 that is coupled to a trailing arm 68 extending up and forward from the axis of revolution 66. On its front end, the trailing arm 68 is coupled to a holder 72 at a joint pivoting about an axis 70 running parallel to the axis of revolution 66. The holder 72 is in turn coupled to the front support 40 (or alternatively to an element coupled thereto, which extends between two front supports 40 arranged laterally side by side) at a vertical axis 74. At least one hydraulic cylinder 80 extends between a lower articulation point 76, which is approximately in the center of the trailing arm 68, and an upper articulation point 78 in the upper region of the holder 72. A piston rod of the hydraulic cylinder 80 is attached to the lower articulation point 76 and a plunger chamber of the hydraulic cylinder 80 is attached to the upper articulation point 78, or vice versa, both being on axes of revolution running parallel to the axes 66 and 70. The plunger chamber of the hydraulic cylinder 80 is connected through a flexible tube 82 to a pneumatic pressure reservoir 84. Preferably, a pressure gauge 86 shows the pressure inside the pressure reservoir 84. Thus, provided the wheel 34 may swivel or rotate around the vertical axis 74 through the holder 72 and the trailing arm 68.

The loading of the wheel 34 on the ground is defined by the pressure in the pressure reservoir 84 and the hydraulic cylinder 80. This arrangement allows the wheel 34 to absorb any ground unevenness 88 upward and downward, since the trailing arm 68 pivots up and down around the axis 70.

To initially pressurize the pressure reservoir 84, and, if necessary, to later adapt to changing conditions, such as the mass of different crop picking heads 16 or deteriorating road conditions, a hydraulic connection 92 can be connected via a flexible tube temporarily affixed to the hydraulic system of the harvesting machine 10. This allows the pressure in the pressure reservoir 84 to be increased for more massive crop picking heads 16. Furthermore, higher pressures are desirable for even roads, while lower pressures are better for uneven roads. Before a trip the tube may be removed, making the creation of a permanent hydraulic connection between the harvesting machine 10 and the pressure reservoir 84 unnecessary. This hydraulic system of the vehicle 30 also acts as an overload safety device by smoothly absorbing bumps and reducing the peak, transient loads experienced by the component parts.

The foregoing disclosure is the best mode devised by the inventor for practicing this invention. It is apparent, however, that methods incorporating modifications and variations will be obvious to one skilled in the art of agricultural machinery. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

1. A vehicle for supporting a crop picking head of a self-propelled harvester during road use, the vehicle comprising a mounting frame having front and rear ends, at least one wheel extending downward from the frame, the frame including latches configured to removably attach to the crop picking head mounted to the harvester, the wheel being suspended near the front end of frame through a spring element, the spring element having a hydraulic cylinder including a pressure chamber connected to a pressure reservoir such that the pressure chamber forms a closed system with the pressure reservoir; whereby the vehicle reduces the load on the front wheels of a self-propelled harvester during road use.

2. The vehicle according to claim 1, further comprising a holder attached to the front end of the frame and a trailing arm with forward and aft ends, the trailing arm being attached at the forward end to the holder through a joint that pivots around a horizontal axis, and the wheel being attached to the aft end of the trailing arm for rotation about a wheel axis, the horizontal axis being parallel to the wheel axis wherein the hydraulic cylinder extends between the trailing arm and the holder.

3. The vehicle according to claim 2 wherein the holder is attached to the frame through a swivel joint that rotates around an approximately vertical axis.

4. The vehicle according to claim 3 wherein the vertical axis is positioned forward of the wheel axis.

5. The vehicle according to claim 2 wherein the trailing arm extends generally rearward from the holder.

6. The vehicle according to claim 2 wherein the trailing arm is connected to the spring element at a position between the fore and aft ends of the trailing arm.

7. The vehicle according to claim 5 wherein the position is generally midway between the fore and aft ends.

8. The vehicle according to claim 1 including a hydraulic connection attached to the hydraulic cylinder, wherein the hydraulic connection is configured to be temporarily attached to a hydraulic system of the harvester for the purpose of setting the initial pressure in the pressure reservoir.

9. The vehicle according to claim 8 wherein the hydraulic connection is attached to the pressure reservoir.

10. The vehicle according to claim 8 wherein the hydraulic connection is attached to a tube positioned between the hydraulic cylinder and the pressure reservoir.

11. The vehicle according to claim 1, wherein the vehicle is attached to a crop picking head and the crop picking head is attached to a self-propelled harvester.
